(19) United States
(12) Patent Application Publication
(10) Pub. No.: US 2026/0145355 A1
(43) Pub. Date: May 28, 2026

(54) Method, System, Cutting Head, And Centrifugal Cutter For Cutting An Electroporated Process Material

(71) Applicant: ELEA Service GmbH, Quakenbruck (DE)

(72) Inventors: Kevin Hill, Osnabruck (DE); Stefan Topfl, Osnabruck (DE)

(21) Appl. No.: 19/391,441

(22) Filed: Nov. 17, 2025

(30) Foreign Application Priority Data
Nov. 22, 2024 (DE) 102024134524.1

(51) Int. Cl. B26D 7/28; B26D 5/00; B26D 5/08; B26D 7/26

(52) U.S. Cl. CPC B26D 7/28; B26D 5/007; B26D 5/08; B26D 7/26

(57) ABSTRACT

The present invention relates to a method, a system (1), a cutting head (35), and a centrifugal cutter (27) for cutting an electroporated process-material (2a) into pieces (2b) of a specific nominal thickness. In order to enable cutting an electroporated process-material (2a) into cut pieces (2b) of uniform quality, the system (1) comprises an electroporator (3), a cutting device (4), the cutting gap (40) of which can be adjusted to a defined gap width (41), a measuring device (5) for detecting a measured thickness (tₘₑₐₛ) of the cut pieces (2b) of the process-material, and a controller (6) in which the nominal thickness and/or the set gap width is stored as a nominal size (tₙₒₘ), wherein the controller (6) is configured to compare the detected measured thickness (tₘₑₐₛ) of the cut pieces (2b) with the nominal size (tₙₒₘ), wherein, if the measured thickness (tₘₑₐₛ) of the cut process-material (2b) deviates from the nominal size (tₙₒₘ), the controller (6) is further configured to output a control signal (17) compensating for the deviation to the electroporator (3) and/or the cutting device (4).

The invention relates to a method for cutting an electroporated process-material, in particular a biological process-material such as fruit or vegetables, into pieces of a specific nominal thickness, comprising the steps of: electroporating the process-material and cutting the electroporated process-material using a cutting device having a cutting gap of a defined cutting width.

The present invention further relates to a system for cutting an electroporated process-material into cut pieces of a specific nominal thickness, comprising an electroporator and a cutting device with a cutting gap that can be adjusted to a defined cutting width.

A further aspect of the present invention is a cutting head, in particular for a centrifugal cutter, for cutting an electroporated process-material, with an annular side wall on which at least one cutting blade is mounted, wherein the at least one cutting blade extends from the side wall inwardly such that a cutting opening with a cutting gap is formed between the side wall and the at least one cutting blade, wherein a gap width of the cutting gap corresponds to the radial distance between the side wall and a distal cutting edge of the at least one cutting blade.

Finally, the present invention relates to a centrifugal cutter for cutting an electroporated process-material, with a stationary cutting head and a running wheel for rotating the process-material in a direction of rotation against the side wall of the cutting head.

Cutting process-material, for example, slicing potatoes or other plant roots or tubers for the production of chips, is known and is carried out using slicers. Such slicers used in the production of chips typically comprise a stationary annular cutting head which comprises one or more cutting blades mounted thereon and which surrounds/encloses a rotatable running wheel with guide elements. As the running wheel rotates, potatoes picked up by the annular cutting head are pressed against the annular side wall of the cutting head by the centrifugal force generated by the running wheel, optionally assisted by guide elements of the running wheel, and moved along the cutting blades mounted thereon. The potatoes are cut into slices at the cutting edge and exit the cutting head through the cutting gap between the cutting edge and the side wall having a thickness that corresponds to the gap width of the cutting gap. Such centrifugal cutters are known, for example, from DE 11 87 846 A, EP 695 31 201T2 , or EP 2 012 982B1.

To improve cutting a process-material, in particular a biological process-material such as potatoes, the process-material can be electroporated prior to the cutting process, which facilitates the cutting process, produces a lower proportion of waste, and requires less energy.

However, electroporation of the process-material can negatively impact cutting and the subsequent process steps, such as deep-frying the cut pieces, or the properties of the final product, such as of deep-fried food such as chips, and can lead to undesirable changes in the final product. For example, it has been found that deep-fried chips can have excessively high residual moisture if the frying time for slices made from electroporated potatoes is not extended.

It is therefore the object of the present invention to provide a method and a system for cutting electroporated process-material that enables uniform quality of the cut pieces and the food products produced therefrom.

The invention solves this problem by providing a method for cutting an electroporated process-material into pieces of a specific nominal thickness, comprising the following steps:
electroporating the process-material;
cutting the electroporated process-material with a cutting device having a cutting gap of a defined gap width;
determining a measured thickness of the cut pieces of the process-material;
comparing the measured thickness with the defined gap width and/or with the nominal

thickness as the nominal size; and
if the measured thickness of the cut pieces deviates from the nominal size, compensating for the deviation by changing an electroporation parameter and/or a cutting parameter.

The invention further solves this problem by providing a system for cutting an electroporated process-material into pieces of a specific nominal thickness. The system according to the invention comprises an electroporator, a cutting device, the cutting gap of which can be adjusted to a defined gap width, a measuring device for detecting a measured thickness of the cut pieces of the process-material, and a controller in which the nominal thickness and/or the set gap width is stored as a nominal size, wherein the controller is configured to compare the detected measured thickness of the cut pieces with the nominal size, wherein the controller is further configured, if the measured thickness deviates from the nominal size, to output a control signal compensating for the deviation to the electroporator and/or the cutting device.

A cutting head according to the invention can be used in such a system, in particular, for cutting an electroporated process-material. The cutting head according to the invention is characterized in that the cutting head comprises an actuatable adjustment mechanism for adjusting the gap width, wherein the adjustment mechanism comprises a movable adjusting element connected to the cutting blade in a force-transmitting manner, and a force transmitter for moving the adjusting element.

The cutting head according to the invention can be part of a centrifugal cutter according to the invention for cutting an electroporated process-material which further comprises a running wheel for rotating the process-material in a direction of rotation against the side wall of the cutting head.

Electroporating the process-material can indeed facilitate its cutting into pieces. It was surprisingly found, however, that when deep-frying cut pieces of an electroporated process-material, a longer deep-frying time is required or that the product has excessive residual moisture. This is due to the unexpected circumstance that the thickness of the cut pieces when cutting an electroporated process-material is greater than the gap width set at the cutting device. Due to the increased compressibility of the process-material after electroporation, the thickness of the cut piece, for example, the thickness of potato slices, surprisingly increases by approximately one-tenth of a millimeter, which is relevant in the production of deep-fried chips. Because the slice thickness influences properties of the final product, such as the crispness of the product. The unforeseen increase in the slice thickness of electroporated cut process-material also changes the surface-to-volume ratio which also affects the required deep-frying time, oil absorption, the content of thermally induced reaction products, and the product yield.

In order to produce a final product with the desired product properties and uniform quality from the cut pieces of an electroporated process-material, it is provided according to the invention that the measured thickness of the cut pieces of the process-material be determined as a measured variable, i.e., to measure the thickness of the cut pieces. The measured thickness determined is then compared with a nominal size, the gap width, and/or the nominal thickness desired, and the undesirably increased slice thickness is compensated for if the thickness measured deviates from the nominal size. According to the invention, compensation is achieved by changing an electroporation parameter and/or a cutting parameter in order to in fact cut the electroporated process-material into pieces having the nominal thickness and prevent thicker pieces. In this way, the present invention compensates for any unexpected changes in the thickness of cut pieces caused by electroporation and ensures that the pieces actually cut are of the thickness specified.

The invention can be further improved by the following configurations which are advantageous by themselves and which may be combined with one another arbitrarily.

According to a first possible embodiment, the measured thickness of the cut pieces can be measured inline, i.e., during ongoing operation. The measured thickness can be measured optically, acoustically, and/or electromagnetically. In an exemplary embodiment, the measuring device can comprise an optical, acoustic, and/or electromagnetic measuring device. Thickness measurement using ultrasound, X-rays, or other non-contact measuring principles is conceivable.

The measuring device of the system can be oriented to the cutting device. Surprisingly, the effect of an unwanted increase in slice thickness occurs immediately after cutting. Therefore, the thickness of the cut pieces measured can be measured immediately after or even during cutting. The thickness measured can of course also be determined elsewhere, and measuring devices can be provided at other points in the system. Other conceivable measuring points are, for example, in a stage downstream of the cutting device, such as a conveyor belt on which the cut pieces are transported away from the cutting device. Using the example of chips production, the measured thickness can also be determined after a washing step or blanching.

Of course, the measured thickness of the cut pieces can also be determined offline. The measuring principles and measuring devices described above can generally be used for this purpose. Alternatives, such as a micrometer screw or a caliper, can also be employed.

According to one embodiment, the measured thickness of the cut pieces is determined optically. The optical measurement can be performed, for example, by capturing images of the cut pieces and electronically or digitally evaluating the captured images. For this purpose, the measuring device can comprise, for example, a camera or an ultrasonic measuring device oriented to the cutting gap. In this embodiment, the piece of the cut process-material exiting through the cutting gap can be captured with a camera, and the thickness measured can be determined based on the image. This embodiment is easy to implement, is flexible for almost any thickness, and delivers good measurement results inline during ongoing operation.

For optical measurement or digital image capture, respectively, a CCD array sensor or a CMOS sensor can optically capture the cut pieces. The images can be evaluated electronically using an algorithm that, for example, determines the circumferential width of a slice as a cut piece or a diagonal cross-section as the strip thickness of a piece cut into strips. For this purpose, according to one embodiment, the measuring device can comprise an evaluation unit that associates a specific thickness of the cut piece with a measurement signal from the measuring device.

Electroporation is a method of making cell membranes temporarily or permanently permeable. This technique is used, inter alia, in microbiology to infiltrate DNA into cells. Electroporation is used also in the field of food and bioprocess engineering to improve mass transport processes or the inactivation of microorganisms. One advantage of electroporation is that it is a non-thermal process.

According to an embodiment, the electroporator can comprise at least two electrodes connected to a pulse generator. The electrodes can preferably be made of stainless steel or titanium, even if they do not need to be exposed to the medium to be treated. The two electrodes form a capacitor, and the space between the two electrodes forms the treatment chamber of the electroporator in which the pulsed electric field is generated. The electrodes can be arranged coaxially, collinearly, conically or parallel to each other and create an electric field as homogeneous as possible for the uniform treatment of the medium. The pulse generator as a voltage source can be, for example, a high-voltage pulse generator with a pulse transformer or a Marx generator with which electrical pulses of a high voltage in the kilovolt range and a short duration in the nano to microsecond range can be generated. Various electrode shapes can be used in the capacitor. Plate, ring, grid, hollow, conical, or flow-through electrodes are possible.

According to a further embodiment, the energy input introduced into the process-material during electroporation as an electroporation parameter can be changed for compensation. If, according to one embodiment, the nominal thickness of the cut pieces is used as the nominal size, and if the measured thickness is greater than the nominal thickness specified, then a compensating control signal can be output in this embodiment to the electroporator, whereupon the energy input as an electroporation parameter is reduced. For example, the number of pulses or the strength of the electric field can be reduced. The reduced energy input reduces the effect of electroporation and lowers the compressibility of the electroporated process-material. Due to the reduced compressibility, the thickness of the cut pieces measured does not increase as much during cutting and when passing through the cutting gap of a defined gap width. As a result, this means that a reduced energy input can reduce an undesirable difference between the defined gap width of the cutting gap at the cutting device and the actual thickness of the cut pieces, i.e., the measured thickness that is determined. For this purpose, the controller in one embodiment of the system according to the invention can be connected to the electroporator in a manner transmitting signals.

According to the invention, the conveying speed of a process-material transported through the electroporator and/or an operating parameter of the electroporator as an electroporation parameter can be changed.

By selecting the electroporation parameters, a defined energy input of, for example, 1 kJ/kg can be achieved in the biological process-material during electroporation. In the electroporator, for example, the strength of the electric field, the pulse shape, the number of pulses, the energy applied, the pulse duration, the pulse frequency, the pulse voltage, the polarity, the amperage, the specific energy, and/or the treatment duration can be changed as possible electroporation parameters to compensate for the deviation between the thickness measured and the nominal size.

According to one embodiment, the electroporator comprises a conveying stretch for transporting the process-material through its treatment chamber. The conveying stretch can comprise a pipeline, a conveyor belt, a chain conveyor, and/or a screw conveyor as the conveying stretch. The electroporator can further comprise a drive for transporting the medium, for example, a pump or a motor.

According to one embodiment, the conveying speed of the process-material is determined when transported through the electroporator. For this purpose, a speed sensor can be provided for determining the conveying speed, or, for example, a frequency converter can be used for reaching a defined conveying speed. The conveying speed as an electroporation parameter can be changed.

The controller can change, for example, the speed of the drive in order to change the conveying speed. The controller can be connected via a control line to the conveying stretch or the drive and/or the pulse generator of the electroporator. In the present invention, the control signals can

be transmitted both in a wired and wireless manner, for example, via signal lines or using radio technology.

In a further embodiment, the system comprises an energy measuring unit for determining the specific energy input into the process-material during treatment with the pulsed electric field, i.e., during electroporation. For example, an oscilloscope or determining the pulse current and pulse voltage can be used as the energy measuring unit. The energy measuring unit can determine the specific energy input as a function of the conveying speed determined and the operating parameters of the electroporator. If the energy measuring unit is coupled to the controller, it can be ensured that either the conveying speed and/or the operating parameters of the electroporator as electroporation parameters are changed according to the control signal.

According to a further embodiment, the gap width and/or the press-on force of the process-material as a cutting parameter can be changed during cutting. If, for example, the measured thickness determined is greater than the nominal thickness specified as the nominal size, then the gap width as a cutting parameter can be changed, usually be reduced. In this embodiment, the invention also compensates for unintentionally thicker pieces which can surprisingly be larger than the gap width of the cutting gap when cutting electroporated process-materials. In this embodiment, the cutting gap can be set to a gap width that is smaller than the nominal thickness of the cut piece in order to compensate for the undesirable increase in slice thickness when cutting electroporated process-materials and to cut the electroporated process-material into pieces of the desired nominal thickness specified.

In another embodiment, the press-on force of the electroporated process-materials as a cutting parameter can be changed during cutting, for example, by reducing the speed of rotation of a centrifugal cutter or the advance rate of linear cutting devices. Reducing the press-on force results in the electroporated process-material being compressed less during cutting and consequently expanding less after being cut to compensate for the compression. This means that the actual thickness of the cut pieces increases less the lower the press-on force on the electroporated process-material is during cutting. If the thickness measured is greater than the nominal thickness specified, then the press-on force in this embodiment can be reduced and the deviation, i.e., the undesirable increase in the thickness of the cut piece, can thus be compensated.

In a further exemplary embodiment, the defined gap width during cutting, which is set on the cutting device, can be compared as a nominal size to the thickness of the cut pieces measured. If the measured thickness is greater than the gap width, thicker pieces than expected are cut. This can be compensated for according to the invention, for example, as described above, by changing an electroporation parameter and/or a cutting parameter or by outputting a control signal in the system according to the invention to the electroporator and/or the cutting device that compensates the deviation.

Of course, it is also possible to consider both the gap width and the specific nominal thickness as nominal sizes in the method or system according to the invention. The nominal thickness and the gap width in one embodiment are both stored as nominal sizes, wherein by default (i.e., at the beginning of the method or when starting up the system), the nominal thickness is initially equal to the gap width, i.e., the size of the cutting gap can be stored in the system's control system as the nominal thickness specified by default.

It is likewise conceivable in one embodiment within the context of the present invention to use a compensation algorithm that generates the control signal, according to which the electroporation parameters and/or cutting parameters, in particular the gap width, the energy input, and the press-on force, are changed.

According to a further embodiment of the system according to the invention, the cutting device can comprise an actuator connected to the control signal transmission for adjusting the gap width and/or for adjusting the press-on force of the process-material at the cutting gap. This configuration makes it possible to perform the compensation according to the invention inline during ongoing system operations. An actuator is understood to be a device that converts the control signal output by the controller into a mechanical motion (e.g., a change in the position of a cutting blade), force (e.g., the torque of a motor), or pressure (e.g., a pressure generator or a press-on device of the cutting device).

In the system presently described, the controller can be connected to the measuring device, the electroporator, for example, its control unit, pulse generator, or conveyor device, and/or to the actuator in a signal-transmitting manner in order to perform the compensation according to the invention.

The cutting device can have fixed or movable cutting edges or cutting blades, respectively. The movable cutting edges can be driven by a motor. In one embodiment, the system can comprise a centrifugal cutter and/or a linear cutter as the cutting device. Based on a control signal received, the actuator can change, for example, the position or orientation of a cutting blade, the rotational speed of the running wheel of a centrifugal cutter, and/or the conveying speed or the die pressure of a linear cutter.

The invention therefore basically allows for the adjustment of the cutting device when the electroporated process-material is cut, and/or of the electroporator during electroporation of the process-material, even inline, for compensating for the unexpectedly occurring shape change when cutting electroporated process-materials.

In addition to the thickness of the cut pieces measured, other process parameters can be measured and taken into account (as measured variables) in the compensation step in a further embodiment. In one embodiment, an impulse and/or a force acting upon the process-material during cutting can be detected as a further process parameter. Possible further process parameters can be determined by way of sound and/or force measurements during cutting. The content of substances escaping from the cut piece, such as reducing sugars and/or the moisture content, color, and fat content of the final product, such as deep-fried chips, can also be further process parameters. All of these additional process parameters can be taken into account, for example, in a compensation algorithm. If, for example, the color of the final product is too dark, then this may indicate that an undesirable Maillard reaction is occurring during the deep-frying of starchy process-materials. This indicates that the raw material contains a high proportion of reducing sugars. The release of sugars can be controlled by adjusting the electroporation parameter. Reducing the energy input reduces the release of reducing sugars, while increasing the energy input, in combination with a subsequent washing step, can lead to leaching from the slices or pieces. In this exemplary configuration, the compensation algorithm could output a control signal to the electroporator to use the energy input not only to prevent unwanted browning of the final product, but also to compensate for the unwanted increase in the cutting thickness of the piece.

The measuring device can comprise a force and/or an impulse meter for detecting a further process parameter. A speed sensor and/or an acoustic measuring device, e.g., a sound meter, can be used or be part of a system of an exemplary embodiment for determining a force or impulse as a further process parameter. The force meter can measure, for example, a torque in a cutting device with movable cutting edges or a torque of the running wheel of a centrifugal cutter. Using such measuring devices, a further process parameter, such as a cutting resistance and/or a cutting force applied, can be determined. This cutting resistance reflects a specific impulse or force that occurs during cutting and can, for example, be determined as a torque.

Configurations with a cutting device with fixed blades are possible. An impulse or force acting upon the fixed blades can be determined as an additional process parameter. This impulse or force can be measured using a load cell as a measuring device. Alternatively or additionally, an acoustic signal can be recorded that characterizes the impulse with which the biological process-material impacts the fixed blade. For example, a structure-borne sound measurement can be performed in the fixed blades, e.g., in the cutting head of a centrifugal cutter.

In a cutting device with movable blades, for example, a torque can be determined. The torque can be determined at a drive that moves the blades. Alternatively or additionally, a force acting upon the movable blades can be detected as a further process parameter. It is also possible to record a structure-borne sound measurement in the movable blades as a comminution parameter.

A process-material, in particular a biological process-material, is understood to mean any type of biological cells or organic products, i.e., biomass in the broadest sense. The method according to the invention can be used, for example, in the production of foodstuffs or food components. Foodstuffs are understood to be substances consisting substantially of micronutrients that are consumed to nourish the human body. Macronutrients, i.e. carbohydrates, lipids/fats and proteins, provide humans with chemically bound energy. According to one embodiment, the process-material to be cut can be a raw plant material. A raw material within the meaning of the present invention is understood to mean substantially untreated food. The raw material can be, for example, a plant tuber, potato, root, vegetable, or fruit. The raw material can be selected from the group consisting of a tuber vegetable, a root vegetable, a legume vegetable, a pomacious fruit, a stone fruit, and a nut fruit. According to one embodiment, the raw material can be selected from the group consisting of potatoes, sweet potatoes, pumpkin, parsnip, celery, carrots, and beetroot.

According to one embodiment, plant tubers, preferably potatoes, can be cut into slices or strips. The slice thickness then corresponds to the width of the circumferential edge of smoothly cut slices or, in the case of a wave cut, to the width at the edge in the wave trough/peak or at half height. For cut strips, the strip thickness corresponds to the diagonal cross-section.

In particular, a cutting head according to the invention for a centrifugal cutter or a centrifugal cutter according to the invention for cutting an electroporated process-material can be used in the method according to the invention and the system according to the invention, which shall be discussed in more detail below. The cutting head of the invention has the advantage that the cutting gap in a centrifugal cutter can be adjusted inline, i.e., during operation, because it comprises an actuatable, i.e., mechanically operable, adjustment mechanism that can be controlled and with which the gap width is variably adjustable.

According to a further embodiment of the cutting head, the at least one cutting blade can be mounted to be movable, and the adjustment mechanism can be configured to change the radial distance or the angle of the at least one cutting blade to the side wall. The at least one cutting blade can be attached in a support, wherein the support is movable relative to the side wall, e.g., in a slidable or pivotable manner.

In one embodiment, the cutting head comprises several cutting blades, wherein each of the cutting blades is connected to an adjusting element, with which adjusting element the associated cutting blade can be moved and the gap width at this cutting opening can be changed.

The force transmitter can be configured to move at least two, or even each, of the adjusting elements, which synchronizes the adjustment and reduces the number of parts required.

According to one embodiment of the cutting head, the force transmitter can extend at least in part along the annular side wall, enabling a compact design. Furthermore, a force transmitter extending at least in sections along the side wall can move more than one adjusting element and thus change the gap widths of several cutting openings simultaneously.

In another embodiment, the force transmitter can be annular. Such a force transmitter can be arranged coaxially to the side wall and move all adjusting elements, thus change the gap widths of all cutting openings simultaneously and, if necessary, in the same way.“In the same way” means that identical gap widths are set at all cutting openings.

According to a further embodiment, the force transmitter can be a pressure channel filled with air (in the case of pneumatic operation) or a liquid (in the case of hydraulic operation). The pressure channel can originate from an inlet opening and extend to at least one or all of the adjusting elements. The pressure channel can be integrated into or attached to the annular side wall of the cutting head. With this pressure-activated, pneumatic or hydraulic adjustment mechanism, the adjusting element can be a movably mounted pin, slide, lever, or bolt. The adjusting element can be movable relative to the side wall, for example, pivotable relative to the side wall or linearly slidable.

Alternatively, the force transmitter can be an adjusting ring which can be arranged to be movable relative to the adjusting element, for example, rotatable relative to the side wall. One or more adjusting elements can be arranged on the adjusting ring. The adjusting ring can have a toothing, wherein each adjusting element can be formed by a tooth with a steep and a flat flank. The cutting blade in this embodiment can be connected to the flat flank in a force-transmitting manner.

The cutting head according to the invention can be part of a centrifugal cutter according to the invention, which further comprises a running wheel for rotating the process-material in a direction of rotation against the side wall of the cutting head.

The running wheel can be arranged in the cutting head, e.g., coaxially with the annular side wall of the cutting head. The running wheel can comprise guide elements for transporting the electroporated process-material to the side wall as the running wheel rotates. The guide elements can be formed by guide plates or vanes.

In a further embodiment, the cutting head and/or the centrifugal cutter can comprise the actuator already described above in the context of the system according to the invention.

The cutting head and/or the centrifugal cutter can also comprise the controller and/or the measuring device for detecting the measured thickness of the cut pieces of the process-material, as described above in the context of the system according to the invention.

In the following, the invention shall be described by way of example in detail with reference to the drawings using advantageous embodiments. The advantageous further developments and embodiments illustrated there are each mutually independent and can be combined with one another according to the requirement of the application.

There:

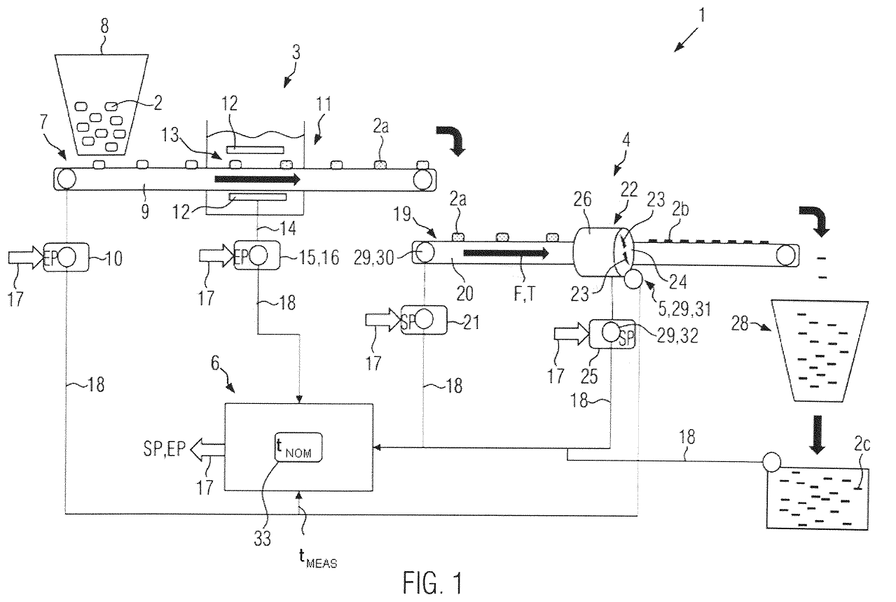

FIG. 1 shows an exemplary embodiment of a system according to the invention for cutting an electroporated process-material;

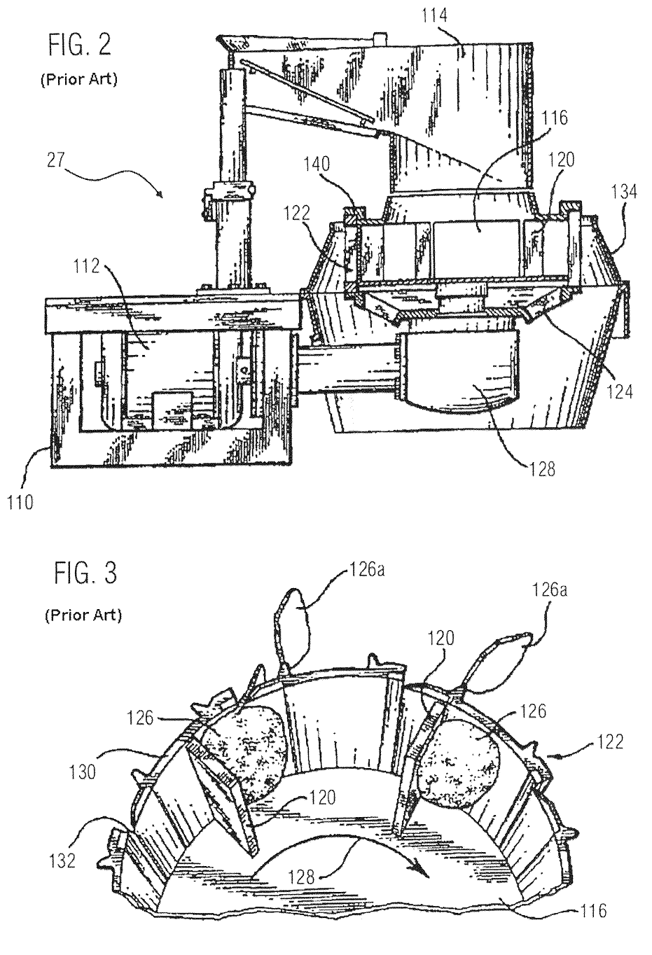

FIG. 2 shows a side view of a known centrifugal cutter with a known cutting head configuration;

FIG. 3 shows a partial perspective view illustrating the known cutting of a process-material;

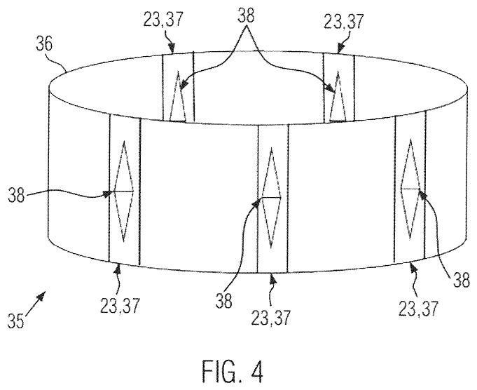

FIG. 4 shows a perspective schematic view of a cutting head of the present invention;

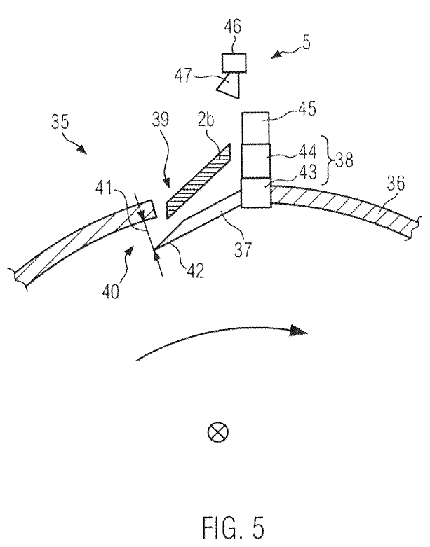

FIG. 5 shows a partial schematic side view of a cutting head of the present invention;

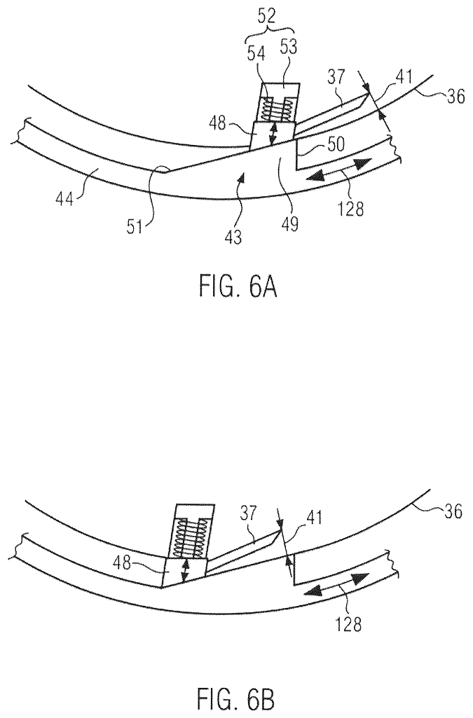

FIG. 6A shows a partial schematic side view of a cutting head of the present invention with an adjustment mechanism of a first embodiment in a first position;

FIG. 6B shows a partial schematic side view of a cutting head of the present invention with the adjustment mechanism of the first embodiment in a second position;

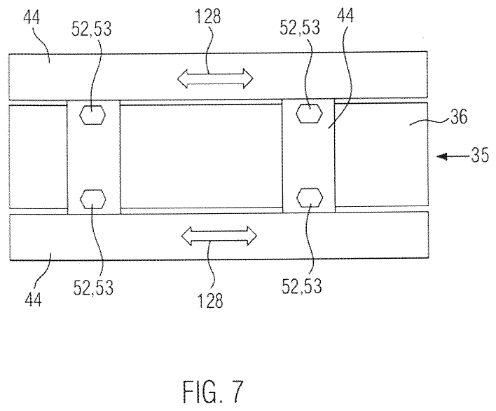

FIG. 7 shows a schematic side view of a cutting head of the present invention with the adjustment mechanism of the first embodiment; and

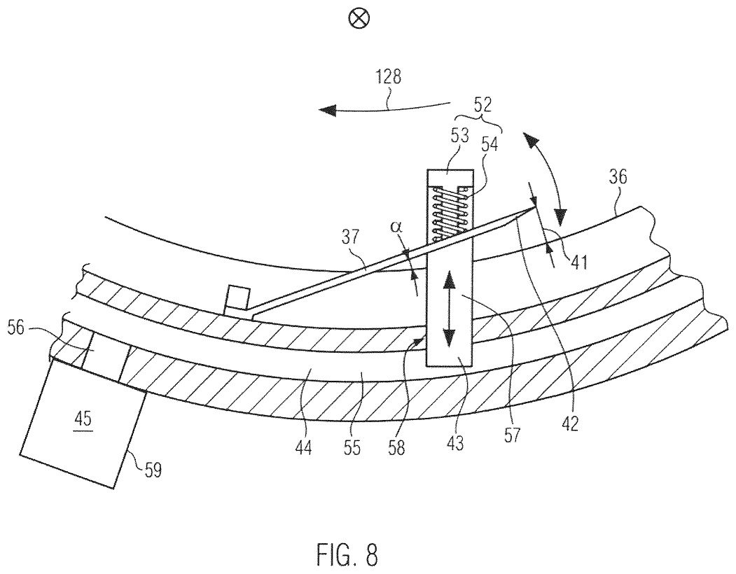

FIG. 8 shows a partial schematic side view of a cutting head of the present invention with an adjustment mechanism of a second embodiment.

An exemplary system 1 for cutting an electroporated process-material 2a is presented hereafter with reference to the schematic illustration of FIG. 1. The example schematically illustrates the system in the context of the production of deep-fried chips. Within the scope of this presentation, the method according to the invention for cutting electroporated process-material 2a, which can be carried out, for example, with system 1 according to the invention, shall also be explained.

System 1 shown in FIG. 1 comprises an electroporator 3 for electroporating process-material 2, for example, biological process-material(schematically represented by small rectangles), with a pulsed electric field. System 1 further comprises a cutting device 4 for cutting electroporated process-material 2a (schematically represented by small rectangles with dots). Cut pieces 2b of the process-material, e.g., strips or slices, are schematically represented in the form of black lines.

System 1 further comprises at least one measuring device 5 for detecting a measured thickness tₘₑₐₛ of cut pieces 2b, and a controller 6 for changing an electroporation parameter and/or a cutting parameter and for compensating for an undesired change in the spatial dimension, in particular, the thickness of cut pieces 2b if the measured thickness determined deviates from a nominal sizetₙₒₘ.

In the embodiment shown, electroporator 3 comprises a conveying stretch 7 for transporting process-material 2, e.g., peeled fruit or vegetables. Process-material 2 is metered onto conveying stretch 7 at one end of conveying stretch 7 by way of a feeding device 8 and moved along the directions of transport indicated by black arrows. In the embodiment shown, conveying stretch 7 comprises a conveyor belt 9 driven by a drive 10. Alternatively, conveying stretch 7 could also comprise an auger conveyor or a pipeline. In the embodiment shown, drive 10 could be a motor that moves conveyor belt 9 at a defined conveying speed F.

Conveying stretch 7 runs through an electroporation unit 11, or in other words, electroporation unit 11 is arranged such that process-material 2 transported on conveying stretch 7 can be treated with a pulsed electric field and thus be electroporated. Electroporation unit 11 comprises at least two electrodes 12 that form a capacitor 13 for generating an electric field in a treatment section of conveying stretch 7. Electrodes 12 of capacitor 13 are connected via energy lines 14 to a voltage source 15. In the embodiment shown, two electrodes 12 of capacitor 13 are arranged on opposite sides of conveying stretch 7 and parallel to each other. A homogeneous electric field for uniform treatment of process-material 2 can be generated with such an electrode arrangement. However, other variants of the electrode arrangement are also conceivable, for example, a coaxial, collinear or conical arrangement.

A pulse generator 16, for example, a high-voltage pulse generator or a Marx generator, can be used as voltage source 15, with which electrical pulses of a high voltage in the kilovolt range and a short duration in the nano to microsecond range can be generated. Electrodes 12 can be produced, for example, from stainless steel or a titanium alloy.

Exemplary system 1 of FIG. 1 comprises a controller 6 configured to output a compensating control signal 17 to electroporator 3 and/or cutting device 4. Control signal 17 can be a signal, e.g., a hydraulic, pneumatic, optical or electrical signal, or a data packet with an instruction or command, which results in an electroporation parameter EP (if the control signal is output to electroporator 3) and/or a cutting parameter SP (if the control signal is output to cutting device 4) being changed.

Electroporation parameter EP can be a conveying speed F of transported process-material 2 and/or at least one operating parameter of electroporation unit 11. Electroporation parameter EP can be set such that a defined energy input [kJ/kg] is supplied by electroporator 3 into process-material 2. If the energy input is to be increased, for example, conveying speed F could be reduced and/or the number of pulses or the strength of the electric field could be increased.

Controller 6 can be connected to drive 10 via a control line 18 (not shown; wireless in the exemplary illustration) and in this way adjust conveying speed F of transported process-material 2 on conveyor belt 9 by controlling drive 10. In the embodiment shown, controller 6 is also connected to electroporation unit 11 wirelessly in a signal-transmitting manner and can in this way adjust, for example, the field strength, the pulse duration, the pulse frequency, the pulse shape, the pulse voltage, and the amperage, thereby controlling the specific energy input as electroporation parameter EP of electroporator 3.

The arrows (white with black outlines) pointing to drive 10 and to electroporation unit 11, respectively, indicate that a control signal 17 can be output wirelessly, for example, via a radio connection, from controller 6 to drive 10 and to electroporation unit 11, respectively. Of course, wired control lines (not shown) can also be used. Although not shown in FIG. 1, data transmission can also be bidirectional, i.e., signals can also be transmitted from drive 10 or electroporation unit 11 back to controller 6. For example, drive 10 can send a conveying signal back to controller 6 which is characteristic of the operation of drive 10, e.g. for example, the rotational speed of a motor.

It applies for all lines that are presented in the context of this invention that they can be configured both in a wired as well as in a wireless manner and that signals or data can be transmitted via these lines not only in the direction indicated by arrows, but also in the opposite direction.

In the exemplary device 1 of FIG. 1, it is therefore possible to control in an open-loop or closed-loop manner, by changing an electroporation parameter EP-for example, the conveying speed of drive 10 or an operating parameter of electroporation unit 11, how much specific energy is introduced by electroporator 3 into process-material 2 that is conveyed on conveying stretch 7 by electroporation unit 11 during its electroporation.

In the embodiment shown, device 1 comprises a second transport stretch 19 for moving electroporated process-material 2a to and through cutting device 4. In the exemplary embodiment shown in FIG. 1, there are two devices present for moving the process-material, a conveying stretch 7 of electroporator 3, and a transport stretch 19 along which cutting device 4 is arranged. Transport stretch 19 in turn comprises a conveyor belt 20 which can be moved by way of a drive 21 for transporting process-material 2 to and through cutting device 4. However, there could also be a single continuous conveyor (not shown) present instead of separate conveyor stretch 7 and transport stretch 19.

Transport stretch 19 runs through cutting device 4 so that a piece of cut process-material 2b is present in direction of transport T downstream of cutting device 4. In the exemplary embodiment, cutting device 4 comprises a linear cutter 22. Exemplary and schematically illustrated linear cutter 22 comprises movable blades 23. Movable blades 23 can be arranged on a rotating cutting disk 24, which cutting disk 24 is rotated by a motor 25. The press-on force of electroporated process-material 2a during cutting can be adjusted by a press-on device 26. For example, transport stretch 19 (or alternatively a die (not shown), which can be part of linear cutter 22) can be used as press-on device 26.

Alternatively, a different cutting device 4 with stationary blades, e.g., a centrifugal cutter 27, can also be part of the system. The basic principle of such a centrifugal cutter 27 according to an example known from DE 695 31 201 T2 shall be explained below with reference to FIGS. 2 and 3. Exemplary embodiments of a centrifugal cutter 27 according to the invention and exemplary embodiments of cutting heads 35 according to the invention shall be discussed in more detail below with reference to FIGS. 4 to 8. Drive 21 of transport stretch 19 as well as motor 25 of cutting device 4 can be connected to controller 6 via control lines 18 in a signal-transmitting manner, as is indicated by the arrows.

Cut pieces 2b are transferred from transport stretch 19 to a deep fryer 28 (for reasons of simplicity, further process steps, e.g., washing or blanching, are omitted). In deep fryer 28, the cut pieces are deep-fried, producing end product 2c, e.g., potato chips (here as well, further process steps, e.g., seasoning, weighing, and packaging, are omitted for reasons of simplicity). An end product measuring device 34 can determine a product property of end product 2c. End product measuring device 40 can use, for example, infrared spectroscopy to determine the product color, oil content, or moisture content of end product 2c and output a corresponding further process parameter via a further device to controller 17. The exemplary embodiment of system 1, shown in FIG. 1, comprises several optional cutting measuring devices 29 for detecting a process parameter and/or a cutting parameter SP. In the exemplary embodiment, a speed sensor 30 is first provided with which the transport speed, at which the electroporated process-material 2a is moved through cutting device 4, can be detected.

A speed measuring device 30 can be used to measure the speed at which the electroporated process-material 2a passes through cutting device 4. The speed can be a cutting parameter SP and a further process parameter which also allows conclusions to be drawn about the effectiveness of the electroporation and thus a statement about whether the intensity of the electroporation is within a desired operating range or outside the operating range. In the exemplary embodiment shown, speed measuring device 30 is integrated into conveyor belt 20.

In FIG. 1, a further cutting measuring device 29, namely a force meter 31, is present. It can determine the force exerted by the electroporated process-material 2a upon blades 23, which can represent a further process parameter and/or a cutting parameter SP. Also conceivable are embodiments in which the cutting measuring device 29 is an impulse meter 32. In the embodiment shown, this impulse meter 32 could determine, for example, the torque of motor 25 which drives rotating blades 23.

In the embodiment shown, controller 6 comprises a comparator 33 for comparing measured thickness tₘₑₐₛ of cut pieces 2b of the process-material as measured by measuring device 5 with a nominal sizetₙₒₘ stored in comparator 33. If measured thickness tₘₑₐₛ of cut pieces 2b deviates from nominal sizetₙₒₘ, then comparator 33 generates a control command, whereupon controller 6 outputs a control signal 17 compensating for the deviation to electroporator 3 and/or cutting device 4 in order to compensate for the deviation by changing an electroporation parameter EP and/or a cutting parameter SP.

The operation of system 1 shown in FIG. 1 could proceed, for example, as follows: Process-materials 2 are fed onto conveying stretch 7 by feeding device 4 and electroporated along conveying stretch 7 by electroporator 3. Electroporated process-materials 2a are transferred to transport stretch 19 and cut into pieces 2b, e.g., slices, in cutting device 4 along transport stretch 19. Cut pieces 2b are transferred to deep fryer 28 where they are processed to become final product 2c.

However, electroporation can cause undesirable changes in the thickness of cut piece 2b. The extent of the change in slice thickness is difficult to estimate in advance and depends on the type, storage duration, and/or the intensity of the electroporation treatment.

To ensure that the cut pieces of electroporated process-material actually have the nominal thickness specified, the measured thickness tₘₑₐₛ of cut pieces 2b of the process-material is determined as a measured variable and compared with a nominal variable tₘₑₐₛ, the gap width and/or the desired nominal thickness and compensated for if the measured thickness tₘₑₐₛ deviates from the nominal variable tₙₒₘ. For this purpose, for example, a measuring device 5, which is aligned with cutting device 4, determines the measured thickness tₘₑₐₛ of piece 2b exiting from cutting device 4. Measuring device 5 sends a measurement signal, which is representative of the thickness measured tₘₑₐₛ, to controller 6. A nominal variable tₙₒₘ is stored in controller 6, e.g. the gap width to which the cutting gap is currently set. By default, when starting

up the system, the gap width can be set to the nominal thickness specified with which electroporated process-materials 2a are to be cut. A comparator 33 of the controller compares measured thickness tₘₑₐₛ with nominal sizetₙₒₘ and outputs a control command if the measured thickness tₘₑₐₛ of cut pieces 2b deviates from nominal sizetₙₒₘ. Based on the control command, controller 6 generates a control signal 17 which is then output by controller 6 via a signal line 18 to electroporator 3 and/or cutting device 4. Output control signal 17 causes electroporator 3 to change an electroporation parameter EP or cutting device 4 of a cutting parameter SP in order to actually cut electroporated process-material 2a into pieces having the nominal thickness.

Control signal 17, for example, can instruct electroporator 4 to reduce the energy input introduced into the process-material during electroporation. For this purpose, for example, the strength of the electric field, the number of pulses, the pulse duration, the pulse frequency, or the treatment duration, i.e. the conveying speed, can be changed. Alternatively or additionally, a control signal 17 can be transmitted to cutting device 4 and instruct it to change, e.g., reduce, the gap width and/or the press-on force of the process-material during the cutting process as cutting parameters. If, for example, the measured thickness determined is greater than the nominal thickness specified as the nominal size, then the gap width, as a cutting parameter, can be changed, usually be reduced. This can result in the cutting gap being set to a gap width that is smaller than the nominal thickness of the cut piece in order to compensate for the undesirable increase in slice thickness when cutting electroporated process-materials and to cut the electroporated process-material into pieces of the desired nominal thickness specified.

Controller 6 can use a compensation algorithm that generates control signal 17 from the measurement signal that is representative of the thickness measured tₘₑₐₛ as well as optionally additional measurement signals from other measuring devices (e.g., a cutting measuring device 29 and/or final product measuring device 34), according to which the electroporation parameters and/or cutting parameters, in particular the gap width, the energy input, and the press-on force, are changed. The compensation algorithm not only ensures that the electroporated process-materials are cut into pieces of the desired nominal thickness specified. The algorithm can also implement the compensation measures initiated by the control signals in the context of the entire system and ensure that other disadvantages do not arise, e.g., an unsatisfactory cutting pattern with increased product waste (if the energy input is reduced too much) or a lower throughput (if the conveying speed is reduced too much).

At this point, the basic principle of a centrifugal cutter 27 and its cutting head shall first be explained with reference to FIGS. 2 and 3 using an example known from DE 695 31 201 T2 .

A known centrifugal cutter 27 is shown in FIG. 2 and comprises a main frame 110 on which a drive motor 112 and a food feed hopper 114 are mounted. The motor drives a running wheel 116 via a gear 118 so that food dropping through the hopper 114 onto running wheel 116 is deflected radially outwardly by centrifugal forces and caused to rotate by contact with running wheel vanes 120. A stationary cutting head 122 is attached to a cutting head support ring 124 which in turn is attached to the housing of gear 118.

As shown in FIG. 2, the rotation of running wheel 116 forces pieces of food 126 around the interior of cutting head 122 in direction of rotation 128. Cutting head 122 comprises a plurality of cutting head support segments 130, each having a blade 132 mounted thereon. Cutting blades 132 are positioned to extend radially inwardly a short distance from the adjacent section of the adjacent cutting support segment such that movement of food 126 in the direction of arrow 128 results in the slices 126a being cut from the food. Outlet 134 surrounding cutting head 122 directs the food slices downwardly into a receiving container (not shown).

Finally, exemplary embodiments of cutting heads 35 according to the invention, which can be parts of exemplary embodiments of a centrifugal cutter 27 according to the invention, are presented with reference to FIGS. 4 to 8.

FIG. 4 shows a perspective schematic view of an exemplary cutting head of the present invention. Cutting head 35 for cutting electroporated process-material 2 comprises an annular side wall 36. Cutting blades 37 are mounted on the side wall. In the example shown, five cutting blades 37 are illustrated as blades 23. Commercially available cutting heads 35 for the production of potato chips comprise 8 or 14 cutting blades 37.

As can be seen in FIG. 5, a partial schematic side view of a cutting head 35, cutting blades 37 extend inwardly from side wall 36, i.e., in the direction of rotation axis (indicated by a cross in a circle in FIG. 5) of side wall 36. Cutting blades 37 protrude inwardly such that a cutting opening 39 with a cutting gap 40 is formed between side wall 36 and at least one cutting blade 37. Gap width 41 of cutting gap 40 corresponds to the radial distance between side wall 36 and a distal cutting edge 42 of at least one cutting blade 37. The radial direction runs from the axis of rotation to side wall 36.

Cutting head 35 comprises an actuatable adjustment mechanism 38 for adjusting gap width 41, which is shown only schematically in FIG. 4 and FIG. 5 and explained in more detail using examples in FIGS. 6 to 8. Adjustment mechanism 38 comprises a movable adjusting element 43 connected to cutting blade 37 in a force-transmitting manner and a force transmitter 44 for moving adjusting element 43. Cutting head 35 according to the invention has the advantage over known cutting heads 122 that the cutting gap can be adjusted inline in a centrifugal cutter 27 because it comprises an actuatable, i.e., mechanically operable adjustment mechanism 38 which can be controlled with a control signal 17 and with which gap width 41 can be adjusted and changed during operation.

At least one or all of cutting blades 37 can be mounted to be movable. Adjustment mechanism 38 acts upon cutting blade 37 to change the radial distance or the angle (α, see FIG. 8) of at least one cutting blade 37 to side wall 36. Cutting blade 37 can be attached in a support 48, wherein support 48 is movable, e.g. in a slidable or pivotable manner. In order to cut electroporated process-material 2a into cut pieces 2b of equal thickness, each of cutting blades 37 is connected to an adjusting element 43. Adjusting element 43 can move associated cutting blade 37 and selectively change gap width 41 at this cutting opening 39.

Measured thickness tₘₑₐₛ of cut pieces 2b can be determined optically, for example, by capturing an image of cut pieces 2b using a measuring device 46, where the captured images are evaluated electronically or digitally, respectively. For this purpose, measuring device 5 can comprise a camera 47 oriented to cutting gap 40.

Force transmitter 44 can be configured to move at least two, or even each, of adjusting elements 43 with adjustment mechanism 38, which synchronizes the adjustment and reduces the number of parts required. In FIGS. 6 to 8, force transmitter 44 extends along annular side wall 36, enabling a compact design.

A first example of an adjustment mechanism will now be presented with reference to FIGS. 6 and 7.

In this embodiment, force transmitter 44 is configured to be annular and arranged coaxially on the outer side of side wall 36. Annular force transmitter 44 is rotatable relative to side wall 36 and comprises a toothing as adjusting elements 43, wherein each adjusting element 43 is formed by a tooth 49 having a steep flank 50 and a flat flank 51. Teeth 49, as well as cutting blades 37 on side wall 36, are distributed at equal intervals along the circumference of annular force transmitter 43. In this embodiment, cutting blade 37 or its support 48 is connected to flat flank 51 in a force-transmitting manner. Support 48 is pressed against flat flank 51 by a holding-down device 52. The holding-down device can be a screw 53 that secures a spring 54, wherein spring 45 exerts a press-on force upon support 48 that is directed toward adjusting element 43.

If annular force transmitter 44 is rotated in direction of rotation 128 relative to side wall 36, support 48 slides along flat flank 51. If annular force transmitter 44 is rotated from a first position, shown in FIG. 6A, e.g., to the right, then support 44 slides down flat flank 51 under the press-on force of holding-down device 52, whereby support 48 and associated cutting blade 37 move radially outwardly in the direction toward side wall 36. This reduces gap width 41 between cutting edge 42 of cutting blade 37 and side wall 36, as can be seen in FIG. 6B which shows annular force transmitter 44 in a second position.

In order to be able to move the cutting blades uniformly relative to side wall 36, as shown in FIG. 7, two annular force transmitters 44 can be used, one of which is associated with the upper and the other with the lower region of side wall 36.

All adjusting elements 43 can be moved with such an annular force transmitter 44 and gap widths 41 of all cutting openings 39 can thus be changed simultaneously and uniformly, which means that identical gap widths 41 are set at all cutting openings 39.

According toa further embodiment shown in FIG. 8, force transmitter 44 can be a pressure channel 55 filled with air (in the case of pneumatic operation) or a liquid (in the case of hydraulic operation). Pressure channel 55 can originate from an inlet opening 56 and extend to at least one or to all adjusting elements 43. Pressure channel 55 can be integrated into annular side wall 36 of cutting head 35 (not shown) or, as in the example of FIG. 8, attached thereto. In the pressure-activated adjustment mechanism 38 shown, the adjusting element 43 is configured as a bolt 57 mounted to be movable. Bolt 57 is mounted in a sliding bearing 58 so that it can slide in a straight line in the radial direction, as indicated by the double arrow.

Bolt 57 acts from below, i.e., in the radial direction, upon the distal free end of cutting blade 37 just forward of its cutting edge 42. From above, i.e., from the axis of rotation in the direction of side wall 36, the cutting blade is pressed by a holding-down device 52 against bolt 57. The other proximal end of cutting blade 37 disposed opposite cutting edge 42 is attached to be immovable.

In this embodiment, compressed air or a hydraulic fluid under pressure is present in pressure channel 55. The pressure is transferred to bolt 57 and moves the latter radially towards the axis of rotation until the pressure on the bolt is in equilibrium with the counterpressure of holding-down device 52. If the pressure in pressure channel 55 is increased, for example, by a compressor 59 connected to inlet opening 56 of actuator 45, then bolt 57 moves radially towards the axis of rotation, cutting blade 37 pivots inwardly in the direction towards the axis of rotation, and angle α between cutting blade 37 and side wall 36 and therefore gap width 41 increases. If the pressure in pressure channel 55 is reduced, then the force of spring 54 of holding-down device 52 exceeds the pressure in pressure channel 55, spring 54 pushes bolt 57 radially away from the axis of rotation. Cutting blade 37 pivots in the direction of side wall 36 and angle α between cutting blade 37 and side wall 36 and therefore gap width 41 decreases.

Cutting head 35 of the present invention can be part of a centrifugal cutter 27 according to the invention, which further comprises a running wheel 116 for rotating the process-material in a direction of rotation 128 against side wall 36 of cutting head 35. Running wheel 116 can be arranged in cutting head 35, e.g., coaxially with annular side wall 36 of cutting head 35. The running wheel can comprise guide elements, e.g., vanes 120, for transporting electroporated process-material 2a to side wall 36 as the running wheel rotates. The centrifugal cutter can be of the known type, as shown, for example, in FIG. 2, but having a cutting head 35 according to the invention installed.

Cutting head 35 and/or centrifugal cutter 27 can comprise actuator 45 already described above in the context of system 1 according to the invention.

Cutting head 35 and/or centrifugal cutter 27 can also comprise controller 6 and/or measuring device 5 already described above in the context of system 1 according to the invention for detecting measured thickness tₘₑₐₛ of cut pieces 2b of the process-material. LIST OF REFERENCE CHARACTERS
1 system
2 process-material
2a electroporated process-material
2b cut pieces
2c end product
3 electroporator
4 cutting device
5 measuring device
6 controller
7 conveying stretch
8 feeding device
9 conveyor belt
10 drive
11 electroporation unit
12 electrodes
13 capacitor
14 energy line
15 voltage source
16 pulse generator
17 control signal
18 control line
19 transport stretch
20 conveyor belt
21 drive
22 linear cutter
23 blades
24 cutting disk
25 motor
26 press-on device
27 centrifugal cutter
28 deep fryer
29 cutting measuring device
30 speed sensor
31 force meter
32 impulse meter
33 comparator
34 end product measuring device
35 cutting head
36 side wall
37 cutting blade
38 adjustment mechanism
39 cutting opening
40 cutting gap
41 gap width
42 cutting edge
43 adjusting element
44 force transmitter
45 actuator
46 measuring device
47 camera
48 support
49 tooth
50 steep flank
51 flat flank
52 holding-down device
53 screw
54 spring
55 pressure channel
56 inlet opening
57 bolt
58 sliding bearing
59 compressor
110 main frame
112 drive motor
114 food feed hopper
116 running wheel
118 gear
120 vanes
122 cutting head
124 cutting head support ring
126 piece of food
126a disks
128 direction of rotation
130 cutting head support segments
132 cutting blade
134 outlet
α angle
EP electroporation parameters
F conveying speed
T direction of transport
SP cutting parameters
tₘₑₐₛ measured thickness
tₙₒₘ nominal size

1. Method for cutting an electroporated process-material (2a) into pieces (2b) of a specific nominal thickness, comprising the steps of:
electroporating a process-material (2);
cutting said electroporated process-material (2a) with a cutting device (4) having a cutting gap (40) of a defined gap width (41);
determining a measured thickness (tₘₑₐₛ) of said cut pieces (2b) of said process-material;
comparing the measured thickness (tₘₑₐₛ) with said defined gap width (41) and/or with the nominal thickness as the nominal size (tₙₒₘ); and
if the measured thickness (tₘₑₐₛ) of said cut pieces (2b) deviates from the nominal size (tₙₒₘ), compensating for the deviation by changing an electroporation parameter (EP) and/or a cutting parameter (SP).

2. Method according to claim 1, wherein the measured thickness (tₘₑₐₛ) of said cut process-material (2b) is measured inline.

3. Method according to claim 2, wherein said piece (2b) of said cut process-material exiting through said cutting gap (40) is recorded with a camera (47), and the measured thickness (tₘₑₐₛ) is determined based on the recording.

4. Method according to claim 1, wherein the energy input during electroporation as an electroporation parameter (EP) is changed for compensation.

5. Method according to claim 1, wherein said gap width (41) and/or a press-on force of said electroporated process-material (2a) as a cutting parameter (SP) is changed during cutting.

6. Method according to claim 1, wherein further process parameters are measured and taken into account in the compensation step.

7. Method according to claim 1, wherein plant tubers as said process-material (2) are cut into slices or strips.

8. System (1) for cutting an electroporated process-material (2a) into pieces (2b) of a specific nominal thickness, comprising
an electroporator (3),
a cutting device (4) whose cutting gap (40) can be adjusted to a defined gap width (41),
a measuring device (5) for detecting a measured thickness (tₘₑₐₛ) of said cut pieces (2b) of said process-material, and
a controller (6) in which the nominal thickness and/or the set gap width is stored as a nominal size (tₙₒₘ), wherein said controller (6) is configured to compare the detected measured thickness (tₘₑₐₛ) of said cut pieces (2b) with the nominal size (tₙₒₘ), wherein said controller (6) is further configured, if the measured thickness (tₘₑₐₛ) of said cut process-material (2b) deviates from the nominal size (tₙₒₘ), to output a control signal (17) compensating for the deviation to said electroporator (3) and/or said cutting device (4).

9. System (1) according to claim 8, wherein said measuring device (5) comprises an optical, an acoustic, and/or an electromagnetic measuring device (46).

10. System (1) according to claim 9, wherein said measuring device (5) comprises a camera (47) or an ultrasonic measuring device which is oriented to said cutting gap (40).

11. System (1) according to claim 8, wherein said cutting device (4) comprises an actuator (45) connected to said controller (6) for signal transmission for adjusting said gap width (41) and/or for adjusting the press-on force of said process-material at said cutting gap (40).

12. System (1) according to claim 8, wherein said cutting device (4) comprises a centrifugal cutter (27) and/or a linear cutter (22).

13. Cutting head (35) for cutting electroporated process-material (2b) with an annular side wall (36) on which at least one cutting blade (37) is mounted, wherein said at least one cutting blade (37) extends from said side wall (36) inwardly such that a cutting opening (39) with a cutting gap (40) is formed between said side wall (36) and said at least one cutting blade (37), wherein a gap width (41) of said cutting gap (40) corresponds to the radial distance between said side wall (36) and a distal cutting edge (42) of said at least one cutting blade (37), and wherein said cutting head (35) comprises an actuatable adjustment mechanism (38) for adjusting said gap width (41), wherein said adjustment mechanism (38) comprises a movable adjusting element (43) connected to said cutting blade (37) in a force-transmitting manner, and a force transmitter (44) for moving said adjusting element (43).

14. Cutting head (35) according to claim 13, wherein said at least one cutting blade (37) is mounted to be adjustable relative to said side wall (36), and said adjustment mechanism (38) is configured to change the radial distance or the angle of said at least one cutting blade (37) relative to said side wall (36).

15. Centrifugal cutter (27) for cutting an electroporated process-material (2a) with a cutting head (35) according to claim 13, and a running wheel (116) for rotating said process-material in a direction of rotation (128) against said side wall (36) of said cutting head (35).

16. System (1) according to claim 9, wherein said cutting device (4) comprises an actuator (45) connected to said controller (6) for signal transmission for adjusting said gap width (41) and/or for adjusting the press-on force of said process-material at said cutting gap (40).

17. System (1) according to claim 10, wherein said cutting device (4) comprises an actuator (45) connected to said controller (6) for signal transmission for adjusting said gap width (41) and/or for adjusting the press-on force of said process-material at said cutting gap (40).

18. System (1) according to claim 9, wherein said cutting device (4) comprises a centrifugal cutter (27) and/or a linear cutter (22).

19. System (1) according to claim 10, wherein said cutting device (4) comprises a centrifugal cutter (27) and/or a linear cutter (22).

20. Centrifugal cutter (27) for cutting an electroporated process-material (2a) with a cutting head (35) according to claim 14, and a running wheel (116) for rotating said process-material in a direction of rotation (128) against said side wall (36) of said cutting head (35).
